(19) United States
(12) Patent Application Publication
(10) Pub. No.: US 2024/0418672 A1
(43) Pub. Date: Dec. 19, 2024

(54) GAS SENSOR

(71) Applicant: DENSO CORPORATION, Kariya-city, Aichi-pref. (JP)

(72) Inventors: Shota IMADA, Kariya-city (JP); Takumi USHIKUBO, Kariya-city (JP)

(21) Appl. No.: 18/816,329

(22) Filed: Aug. 27, 2024

Related U.S. Application Data
(63) Continuation of application No. PCT/JP2022/044152, filed on Nov. 30, 2022.

(30) Foreign Application Priority Data
Feb. 28, 2022 (JP) 2022-029257

(51) Int. Cl. G01N 27/407; G01N 27/406

(52) U.S. Cl. CPC G01N 27/4077; G01N 27/4067; G01N 27/4073

(57) ABSTRACT

A sensor element includes a gas sensor that includes a solid electrolyte body, a heater, and a protective layer. The protective layer covers a detection tip end portion of the sensor element and has a porosity of equal to or greater than 25%. The protective layer includes a shielding side portion and a heater side portion. The shielding side portion is a planar portion on a side of the protective layer on which the solid electrolyte body is positioned in an opposing direction of the solid electrolyte body and the heater. The heater side portion is a planar portion on a side of the protective layer on which the heater is positioned in the opposing direction. A thickness of the shielding side portion is greater than a thickness of the heater side portion.

### CROSS-REFERENCE TO RELATED APPLICATIONS

The present application is a continuation application of International Application No. PCT/JP2022/044152, filed on Nov. 30, 2022, which claims priority to Japanese Patent Application No. 2022-029257, filed on Feb. 28, 2022. The contents of these applications are incorporated herein by reference in their entirety.

### BACKGROUND

### Technical Field

The present disclosure relates to a gas sensor.

### Related Art

For example, a gas sensor is disposed in an exhaust pipe of an automobile and is used to detect various types of gases contained in a gas to be detected, the gas to be detected being exhaust gas flowing through the exhaust pipe. The gas sensor includes, in addition to a sensor element for detecting gas, a housing that attaches the sensor element to the exhaust pipe and the like.

The sensor element includes a solid electrolyte body that is provided with an electrode that is exposed to the gas to be detected, an insulating body that is laminated onto the solid electrolyte body, a heater that is embedded in the insulating body, and the like. In a detection tip end portion in a longitudinal direction of the sensor element, the electrode and a heating portion of the heater are disposed in an opposing manner. A porous protective layer for protecting the sensor element from cracking due to water exposure and the like is provided on a surface of the detection tip end portion.

### SUMMARY

An aspect of the present disclosure provides a sensor element includes a gas sensor that includes a solid electrolyte body, a heater, and a protective layer. The protective layer covers a detection tip end portion of the sensor element and has a porosity of equal to or greater than 25%. The protective layer includes a shielding side portion and a heater side portion. The shielding side portion is a planar portion on a side of the protective layer on which the solid electrolyte body is positioned in an opposing direction of the solid electrolyte body and the heater. The heater side portion is a planar portion on a side of the protective layer on which the heater is positioned in the opposing direction. A thickness of the shielding side portion is greater than a thickness of the heater side portion.

### BRIEF DESCRIPTION OF THE DRAWINGS

In the accompanying drawings:

FIG. 1 is an explanatory diagram illustrating a gas sensor according to a first embodiment;

FIG. 2 is an explanatory diagram illustrating a sensor element according to the first embodiment;

FIG. 3 is a cross-sectional view of the sensor element according to the first embodiment, taken along III-III in FIG. 2;

FIG. 4 is a diagram illustrating another sensor element according to the first embodiment, corresponding to the cross-section along III-III in FIG. 2; and

FIG. 5 is a diagram illustrating a sensor element according to a second embodiment, corresponding to the cross-section along III-III in FIG. 2.

### DESCRIPTION OF THE EMBODIMENTS

In the sensor element, the thickness of the protective layer is set to differ as appropriate in each section around a center axial line in the longitudinal direction of the sensor element for the purpose of preventing occurrence of cracking (cracks) and the like. For example, in a laminated-type gas sensor element and a gas sensor in JP 2009-257817 A, the thickness of the protective layer formed on a side surface orthogonal to the lamination direction is set to be thicker than the thickness of the protective layer formed on surfaces on both sides in the lamination direction to inhibit formation of cracks in a boundary portion between a heater layer that includes a resistance heating body therein and a detection layer that includes a pair of electrodes laminated onto the heater layer, and the like.

As a result of research and development by the inventors, it has become clear that there are various aspects to the mechanism by which cracks form in the sensor element. In a cross-section orthogonal to the longitudinal direction of the sensor element, the temperature on the side on which the heater is disposed becomes relatively high and the temperature on the side on which the heater is not disposed becomes relatively low. Taking this phenomenon into consideration, the thickness in which the protective layer is provided in the cross-section orthogonal to the longitudinal direction of the sensor element requires a design differing from that of a sensor element of a conventional gas sensor including JP 2009-257817 A. In particular, in recent years, in cases in which much earlier activation of the sensor element is required, the speed at which the temperature increases in the sensor element has become faster, and the likelihood of cracks forming in the sensor element due to thermal shock has increased.

It is thus desired to provide a gas sensor that is capable of more effectively reducing a likelihood of cracks forming in a tip end detecting portion of a sensor element.

An exemplary embodiment of the present disclosure provides a gas sensor including a sensor element that detects a gas contained in a gas to be detected. The sensor element includes: a solid electrolyte body in which an electrode that is exposed to the gas to be detected is provided in a detection tip end portion in a longitudinal direction of the sensor element; a heater that includes a heat generating unit in a position opposing the electrode and is disposed opposing the solid electrolyte body; and a protective layer that covers the detection tip end portion and has a porosity of equal to or greater than 25%. The protective layer includes a shielding side portion and a heater side portion. The shielding side portion is a planar portion on a side of the protective layer on which the solid electrolyte body is positioned in an opposing direction of the solid electrolyte body and the heater. The heater side portion is a planar portion on a side of the protective layer on which the heater is positioned in the opposing direction. A thickness of the shielding side portion is greater than a thickness of the heater side portion.

In the sensor element of the gas sensor according to the above-described exemplary embodiment, the porosity of the protective layer covering the detection tip end portion of the sensor element is set to be equal to or less than 25%. As a result of this configuration, thermal conductivity of the protective layer can be appropriately reduced and occurrence of thermal shrinkage from an element body including the solid electrolyte body and the heater to the protective layer is inhibited. In addition, the thickness of the shielding side portion of the protective layer is greater than the thickness of the heater side portion of the protective layer. As a result of this configuration, heat retention effect of the shielding side portion of the protective layer becomes higher than the heat retention effect of the heater side portion of the protective layer. Occurrence of temperature distribution in the opposing direction in the detection tip end portion is inhibited in the course of temperature increase in the detection tip end portion by the heater. Furthermore, the effect of inhibiting the occurrence of thermal shrinkage and the effect of inhibiting the occurrence of temperature distribution are combined, and occurrence of thermal stress in the detection tip end portion of the sensor element can be inhibited.

In the gas sensor according to the above-described exemplary embodiment, the likelihood of cracks forming in the tip end detecting portion of the sensor element can be more effectively reduced.

Here, reference numbers within the parentheses of constituent elements according to an aspect of the present disclosure indicate corresponding relationships with reference numbers in the drawings. However, the constituent elements are not limited to the content according to the embodiments.

The above-described exemplary embodiment of the present disclosure will be further clarified through the detailed description herebelow, with reference to the accompanying drawings.

Preferred embodiments of the gas sensor described above will be described with reference to the drawings.

### First Embodiment

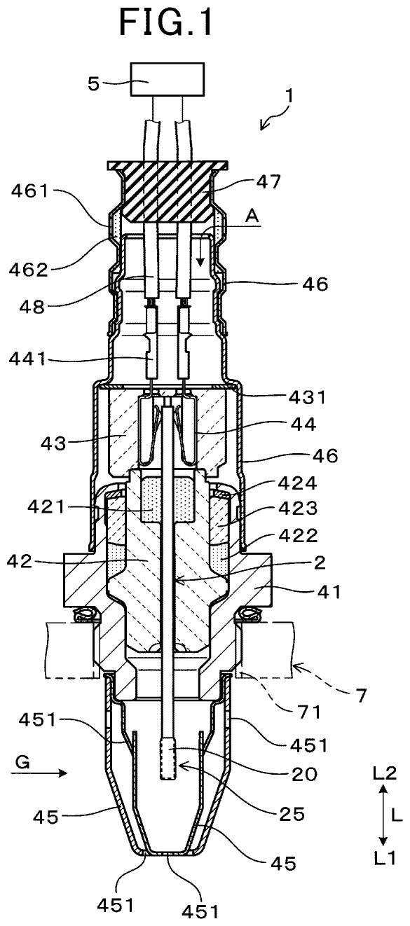

As shown in FIG. 1 to FIG. 3, a gas sensor 1 according to the present embodiment includes a sensor element 2 that detects gas contained in a gas to be detected. The sensor element 2 includes a solid electrolyte body 31, a heater 34, and a protective layer 20. The solid electrolyte body 31 is provided with electrodes 311 and 312 that are exposed to the gas to be detected in a detection tip end portion 25 in a longitudinal direction L of the sensor element 2. The heater 34 is disposed opposing the solid electrolyte body 31 and includes a heat generating unit 341 in a position opposing the electrodes 311 and 312. The protective layer 20 covers the detection tip end portion 25 of the sensor element 2 and has a porosity of 25% or greater. A thickness t2 of a shielding side portion 22 that is a planar portion on a side of the protective layer 20 on which the solid electrolyte body 31 is positioned in an opposing direction D of the solid electrolyte body 31 and the heater 34 is greater than a thickness t1 of a heater side portion 21 that is a planar portion on a side of the protective layer 20 on which the heater 34 is positioned in the opposing direction D.

The gas sensor 1 according to the present embodiment will be described below.

### Gas Sensor 1

As shown in FIG. 1, the gas sensor 1 is disposed in an attachment opening 71 of an exhaust pipe 7 of an internal combustion engine (engine) of a vehicle. The gas sensor 1 is used to detect a concentration of oxygen, a specific gas, or the like as a gas contained in the gas to be detected, the gas to be detected being exhaust gas G that flows through the exhaust pipe 7. The gas sensor 1 may be used as an air-fuel ratio sensor (A/F sensor) that determines an air-fuel ratio in the internal combustion engine based on the concentration of oxygen, unburned gas, and the like in the exhaust gas G.

A catalyst for purifying toxic substances in the exhaust gas G is disposed in the exhaust pipe 7. The gas sensor 1 may be disposed on either of an upstream side or a downstream side of the catalyst in a direction of flow of the exhaust gas G in the exhaust pipe 7. In addition, the gas sensor 1 may be disposed in piping on an intake side of a supercharger that increases density of air taken into the internal combustion engine using the exhaust gas G. Furthermore, the piping in which the gas sensor 1 is disposed may be piping in an exhaust recirculation mechanism that recirculates a portion of the exhaust gas G discharged from the internal combustion engine into the exhaust pipe 7 to an air intake pipe of the internal combustion engine.

### Sensor Element 2

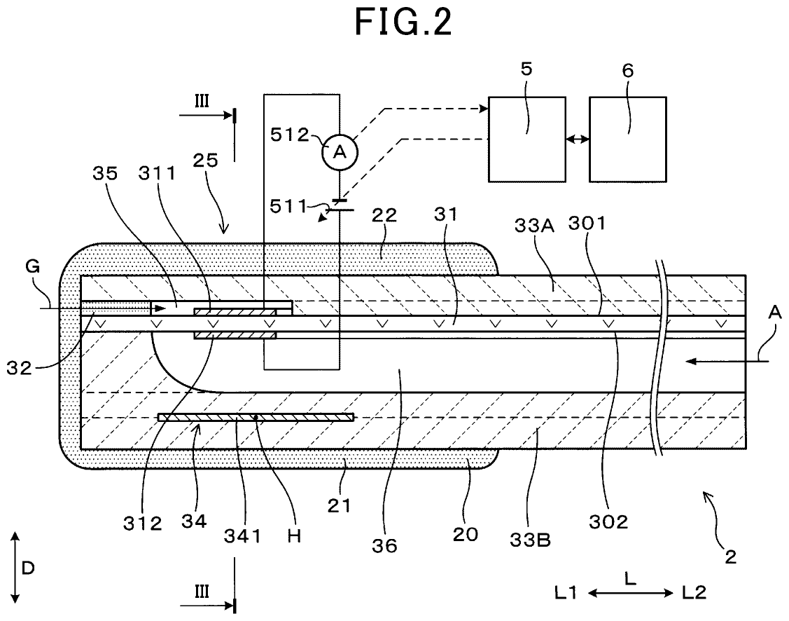

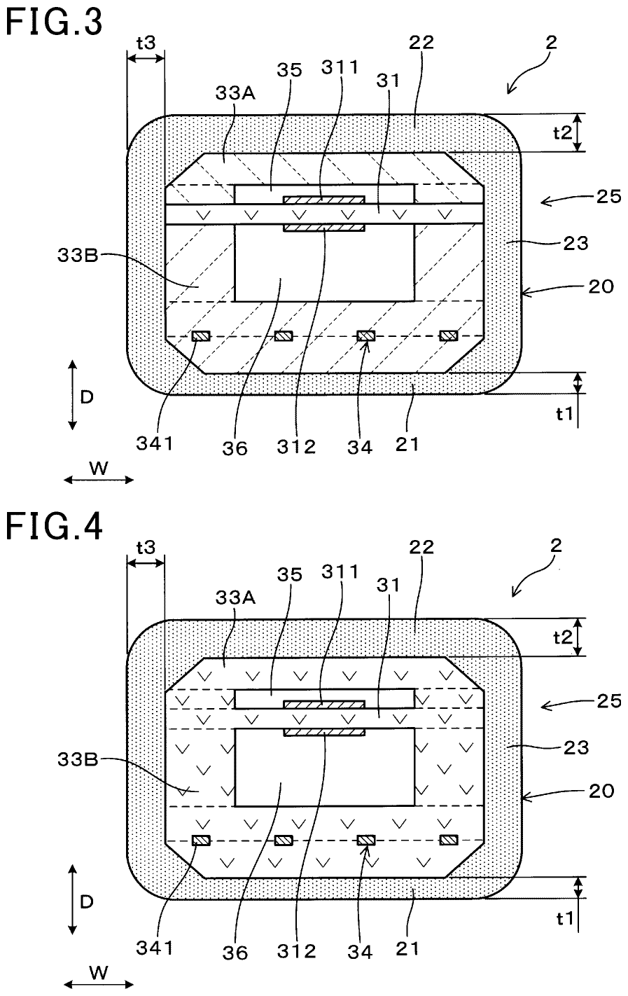

As shown in FIG. 2 and FIG. 3, insulating bodies 33A and 33B are laminated onto the solid electrolyte body 31. The heater 34 is embedded in the insulating body 33B. The solid electrolyte body 31 and the insulating bodies 33A and 33B form a laminated-type sensor element 2. The sensor element 2 is formed in an elongated rectangular shape and is held in a housing in a state of being held by an element holding member 42, described hereafter. The insulating bodies 33A and 33B are configured by a first insulating body 33A that is laminated onto a first surface 301 of the solid electrolyte body 31 and a second insulating body 33B that is laminated onto a second surface 302 of the solid electrolyte body 31. The heater 34 is embedded in the second insulating body 33B.

Here, the heater 34 may be embedded in the first insulating body 33A. In this case, the heater side is the side on which the first insulating body 33A is disposed. The shielding side is the side on which the second insulating body 33B is disposed.

### Longitudinal Direction L, Opposing Direction D, and Width Direction W

According to the present embodiment, the longitudinal direction L of the gas sensor 1 and the sensor element 2 is a direction in which the sensor element 2 extends in the elongated shape. In addition, a direction that is orthogonal to the longitudinal direction L and in which the solid electrolyte body 31 and the insulating bodies 33A and 33B are opposing (direction of lamination) is the opposing direction (lamination direction) D. Furthermore, a direction that is orthogonal to the longitudinal direction L and the opposing direction D is a width direction W. Moreover, in the longitudinal direction L of the sensor element 2, a side exposed to the exhaust gas G is a tip end side L and a side opposite the tip end side L1 is a base end side L2.

### Solid Electrolyte Body 31, Exhaust Electrode 311, and Atmosphere Electrode 312

As shown in FIG. 2 and FIG. 3, the solid electrolyte body 31 has oxygen ion (O²⁻) conductivity at a predetermined activation temperature. An exhaust electrode 311 that is exposed to the exhaust gas G is provided on the first surface 301 of the solid electrolyte body 31, and an atmosphere electrode 312 that is exposed to atmospheric air A is provided on the second surface 302 of the solid electrolyte body 31. The exhaust electrode 311 and the atmosphere electrode 312 are disposed in positions overlapping in the opposing direction D with the solid electrolyte body 31 therebetween in a portion on the tip end side L1 exposed to the exhaust gas G in the longitudinal direction L of the sensor element 2. A sensor cell composed of the exhaust electrode 311, the atmosphere electrode 312, and the portion of the solid electrolyte body 31 sandwiched between the electrodes 311 and 312 is formed in the portion on the tip end side L1 in the longitudinal direction L of the sensor element 2.

The solid electrolyte body 31 is composed of a zirconia-based oxide in which zirconia (zirconium oxide) is a main ingredient (50% by mass or greater) and is composed of stabilized or partially stabilized zirconia in which a portion of zirconia is replaced by a rare earth metal element or an alkaline earth metal element. A portion of the zirconia composing the solid electrolyte body 31 is replaced by yttria, scandia, or calcia.

The exhaust electrode 311 and the atmosphere electrode 312 contain platinum as a noble metal exhibiting catalytic activity to oxygen and a zirconia-based oxide serving as a co-material with the solid electrolyte body 31. As shown in FIG. 1 and FIG. 2, an electrode lead portion for electrically connecting the exhaust electrode 311 and the atmosphere electrode 312 to outside the gas sensor 1 is connected to the electrodes 311 and 312.

### Gas Chamber 35

As shown in FIG. 2 and FIG. 3, a gas chamber 35 surrounded by the first insulating body 33A and the solid electrolyte body 31 is formed adjacent to the first surface 301 of the solid electrolyte body 31. The gas chamber 35 is formed in a position housing the exhaust electrode 311 in a portion on the tip end side L1 in the longitudinal direction L of the first insulating body 33A. The gas chamber 35 is formed as a space portion that is closed by the first insulating body 33A, a diffusive resistance portion 32, and the solid electrolyte body 31. The exhaust gas G flowing through the exhaust pipe 7 passes through the diffusive resistance portion 32 and is introduced into the gas chamber 35.

### Diffusive Resistance Portion 32

As shown in FIG. 2 and FIG. 3, the diffusive resistance portion 32 (gas introducing portion) according to the present embodiment is provided in a portion on the tip end side L1 in the longitudinal direction L of the gas chamber 35. The diffusive resistance portion 32 is formed by a porous body of a metal oxide such as alumina (aluminum oxide) being disposed in an introduction opening formed in the first insulating body 33A. A diffusion speed (flow rate) of the exhaust gas G introduced into the gas chamber 35 is determined by restriction of a speed at which the exhaust gas G passes through the pores of the porous body in the diffusive resistance portion 32. Here, the diffusive resistance portion 32 may be provided on both sides in the width direction W of the gas chamber 35.

### Atmosphere Duct 36

As shown in FIG. 2 and FIG. 3, an atmosphere duct 36 that is surrounded by the second insulating body 33B and the solid electrolyte body 31 and into which atmospheric air A is introduced is formed adjacent to the second surface 302 of the solid electrolyte body 31. The atmosphere duct 36 is formed from a portion housing the atmosphere electrode 312 in the longitudinal direction L of the second insulating body 33B to a base end position in the longitudinal direction L of the sensor element 2.

### Insulating Bodies 33A and 33B

As shown in FIG. 2 and FIG. 3, the first insulating body 33A forms the gas chamber 35 and the second insulating body 33B forms the atmosphere duct 36. In addition, the heater 34 is embedded in the second insulating body 33B. The first insulating body 33A and the second insulating body 33B are formed by a metal oxide such as alumina (aluminum oxide). The insulating bodies 33A and 33B are formed as a dense body through which gas that is the exhaust gas G or atmospheric gas A cannot permeate.

### Heater 34

As shown in FIG. 2 and FIG. 3, the heater 34 is configured as a heat generating body and is embedded inside the second insulating body 33B that forms the atmosphere duct 36. The heater 34 has the heat generating unit 341 that generates heat by energization and a heater lead portion that is connected to the base end side L2 in the longitudinal direction L of the heat generating unit 341. The heat generating unit 341 is disposed in a position in which at least a portion overlaps the exhaust electrode 311 and the atmosphere electrode 312 in the opposing direction D of the solid electrolyte body 31 and the insulating bodies 33A and 33B. The heater 34 is configured by a metal material having conductivity.

The detection tip end portion 25 of the sensor element 2 is formed as a portion on the tip end side in the longitudinal direction L of the sensor element 2 in which the exhaust electrode 311, the atmosphere electrode 312, and the heat generating unit 341 are disposed.

### Protective Layer 20

As shown in FIG. 2 and FIG. 3, the protective layer 20 is composed of a plurality of ceramic particles that are bound together and serving as a ceramic material having pores through which the exhaust gas G can pass. Particles of alumina (aluminum oxide), spinel (spinel), and the like are used in the protective layer 20. The thicknesses t1 and t2 of the protective layer 20 in portions in a cross-section orthogonal to the longitudinal direction L of the detection tip end portion 25 differ as appropriate to inhibit occurrence of temperature distribution within the cross-section.

The cross-section orthogonal to the longitudinal direction L of an element body composed of the solid electrolyte body 31 and the insulating bodies 33A and 33B has a quadrangular shape in which four corner portions are formed by a C plane (tapered surface) or an R plane (curved surface). The element body refers to the sensor element 2 excluding the protective layer 20. A planar portion on the side on which the solid electrolyte body 31 is positioned in the opposing direction D of the solid electrolyte body 31 and the heater 34 is formed as a surface of the first insulating body 33A. A planar portion on the side on which the heater 34 is positioned in the opposing direction D of the solid electrolyte body 31 and the heater 34 is formed as a surface of the second insulating body 33B. The planar portions refer to surfaces parallel to the width direction W excluding the C plane or the R plane.

The thickness t2 of the shielding side portion 22 of the protective layer 20 refers to the thickness t2 of a planar portion on the shielding side, or in other words, a portion of the protective layer 20 provided on the overall surface in the opposing direction D of the first insulating body 33A. The thickness t1 of the heater side portion 21 of the protective layer 20 refers to the thickness t1 of a planar portion on the heater side, or in other words, a portion of the protective layer 20 provided on the overall surface in the opposing direction D of the second insulating body 33B.

The overall thickness t2 of the shielding side portion 22 of the protective layer 20 is greater than the overall thickness t1 of the heater side portion 21 of the protective layer 20. The shielding side portion 22 and the heater side portion 21 of the protective layer 20 are formed so as to be flat. In addition, the thickness t2 in any position in the width direction W of the shielding side portion 22 of the protective layer 20 is greater than the thickness t1 in any position in the width direction W of the heater side portion 21 of the protective layer 20.

In a cross-section orthogonal to the longitudinal direction L of the sensor element 2 in a heat generation center position H in the longitudinal direction L of the heat generating unit 341, the overall thickness t2 of the shielding side portion 22 of the protective layer 20 is equal to or greater than 1.3 times the overall thickness t1 of the heater side portion 21 of the protective layer 20. According to the present embodiment, in the cross-section orthogonal to the longitudinal direction L of the overall position in which the heat generating unit 341 is disposed in the longitudinal direction L of the sensor element 2, the thickness t2 in any position in the width direction W of the shielding side portion 22 of the protective layer 20 is also equal to or greater than 1.3 times the thickness t1 in any position in the width direction W of the heater side portion 21 of the protective layer 20. As a result of this configuration, occurrence of temperature distribution in the cross-section orthogonal to the longitudinal direction L in the detection tip end portion 25 of the heater 34 element can be further inhibited.

Furthermore, the thickness t2 of the shielding side portion 22 of the protective layer 20 is equal to or greater than 498 μm. More specifically, the thickness t2 in any position in the width direction W of the shielding side portion 22 of the protective layer 20 is equal to or greater than 498 μm. As a result of this configuration, a heat retention effect (thermal insulation effect) of the shielding side portion 22 of the protective layer 20 can be appropriately achieved. For example, the thickness t2 of the shielding side portion 22 of the protective layer 20 may be equal to or less than 1000 μm.

The thickness t1 of the heater side portion 21 of the protective layer 20 may be made as thin as possible within a range that enables cracking of the element body of the sensor element 2 due to water exposure to be prevented. For example, the thickness t1 of the heater side portion 21 of the protective layer 20 may be equal to or greater than 100 μm and less than 498 μm.

Moreover, a thickness t3 of a side portion 23 of the protective layer 20 positioned on both sides in the width direction W orthogonal to both the longitudinal direction L and the opposing direction D is greater than the thickness t1 of the heater side portion 21 of the protective layer 20. As a result of this configuration, the heat retention effect in the side portions 23 of the protective layer 20 can be improved. Occurrence of temperature distribution in the cross-section orthogonal to the longitudinal direction L in the detection tip end portion 25 of the sensor element 2 can be further inhibited.

The thickness t3 of the side portion 23 of the protective layer 20 may be less than or greater than the thickness t2 of the shielding side portion 22 of the protective layer 20. In addition, the protective layer 20 is also formed on a tip end surface in the longitudinal direction L of the sensor element 2.

### Measurement Method for the Porosity of the Protective Layer 20

The porosity of the protective layer 20 can be measured by various methods. For example, a cross-section of a portion of the protective layer 20 may be observed under a scanning electron microscope (SEM). A proportion of pores in the cross-section may be calculated by binarization or the like and used as the porosity. Magnification of the SEM may be changed based on grain size and pore size in the protective layer 20. For example, if the grain size of the main materials composing the protective layer 20 and the pore size are in the order of several micrometers to several tens of micrometers, observation may be conducted at about 500 to 2000 times magnification. In addition, a plurality of cross-sections in the protective layer 20 may be observed and an average value of the proportions of the pores in the plurality of cross-sections may be set as the porosity. The unit of porosity is % by volume. However, in practicality, the proportion in the cross-section may be considered % by area.

### Formation Method of the Protective Layer 20

The protective layer 20 may be formed by a slurry of a ceramic material for forming the protective layer 20 being sprayed onto the detection tip end portion 25 of the element body of the sensor element 2 and dried. In this case, the slurry is sprayed so that the shielding side portion 22 of the protective layer 20 is thicker than the heater side portion 21.

In addition, the protective layer 20 may be formed by molding by the detection tip end portion 25 of the element body of the sensor element 2 being disposed inside a mold and the slurry of the ceramic material for forming the protective layer 20 being injected into the mold. In this case, a cavity of the mold is formed so that the shielding side portion 22 of the protective layer 20 is thicker than the heater side portion 21.

Furthermore, the protective layer 20 may be formed by the detection tip end portion 25 of the element body of the sensor element 2 being removed after being immersed in the slurry of the ceramic material for forming the protective layer 20 and dried. In this case, a state after the detection tip end portion 25 of the element body of the sensor element 2 is removed from the slurry is controlled so that the shielding side portion 22 of the protective layer 20 is thicker than the heater side portion 21.

Here, after the protective layer 20 is formed in the detection tip end portion 25 of the element body, the overall sensor element 2 including the protective layer 20 is fired.

### Other Configurations of the Sensor Element 2

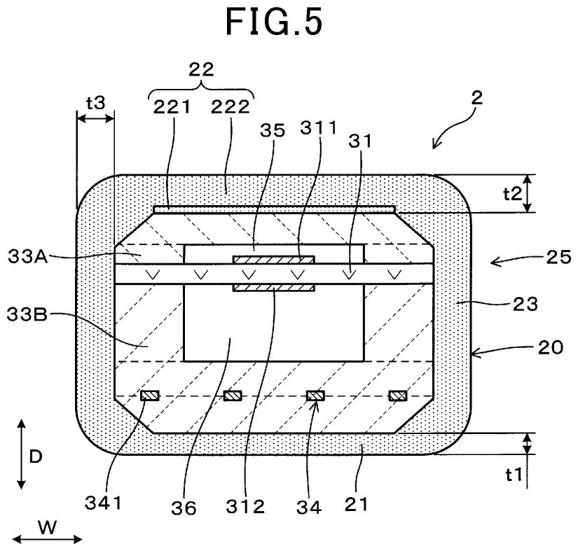

As shown in FIG. 4, the sensor element 2 excluding the protective layer 20 may have a composition in which a proportion of volume occupied by a zirconia material is the largest. Specifically, the insulating bodies 33A and 33B in the sensor element 2 may be composed of a zirconia material instead of an alumina material. The zirconia material may be the same type of zirconia material composing the solid electrolyte body 31. If a large part or most of the element body configured by the solid electrolyte body 31 and the insulating bodies 33A and 33B is composed of the zirconia material, cracks will occur more easily than in the case in which the insulating bodies 33A and 33B are composed of the alumina material. Therefore, in the case of the sensor element 2 having the composition in which the proportion of volume occupied by the zirconia material is the largest, the effect in which occurrence of temperature distribution in the cross section orthogonal to the longitudinal direction L in the detection tip end portion 25 is inhibited can be more noticeably achieved.

In addition, although not shown, the sensor element 2 is not limited to that having a single solid electrolyte body 31 and may have a plurality of solid electrolyte bodies 31. In this case as well, the heater 34 is disposed in a position offset in the opposing direction D. The side closer to the heater 34 in the opposing direction D is the heater side and the side opposite thereto is the shielding side.

### Other Configurations of the Gas Sensor 1

As shown in FIG. 1, the gas sensor 1 includes a housing 41, an element holding member 42, a terminal holding member 43, a contact member 431, a contact terminal 44, a tip end side cover 45, a base end side cover 46, a bush 47, a lead wire 48, and the like to dispose the sensor element 2 in the exhaust pipe 7 and electrically wire the gas sensor 1 to a sensor control apparatus 5.

The housing 41 is used to fasten the gas sensor 1 to the attachment opening 71 of the exhaust pipe 7. The housing 41 holds the sensor element 2 by the element holding member 42 and the like. The sensor element 2 is held by the element holding member 42 with a glass 421 therebetween, and the element holding member 42 is held by the housing 41 with caulking materials 422, 423, and 424 therebetween. The terminal holding member 43 that holds the contact terminal 44 is connected on the base end side L2 in the longitudinal direction L of the element holding member 42. The terminal holding member 43 is supported by the base end side cover 46 by the contact member 431.

The contact terminal 44 electrically connects the electrodes 311 and 312 and the heater 34 to the lead wire 48 in the sensor element 2. The contact terminal 44 is connected to the lead wire 48 by a connection fitting 441 in a state of being disposed in the terminal holding member 43.

As shown in FIG. 1, the tip end side cover 45 is provided on the tip end side L1 in the longitudinal direction L of the housing 41 and covers the detection tip end portion 25 of the sensor element 2. A gas circulation hole 451 through which the exhaust gas G that comes into contact with the sensor element 2 can circulate is formed in the tip end side cover 45. The detection tip end portion 25 of the sensor element 2 and the tip end side cover 45 are disposed in the exhaust pipe 7 of the internal combustion engine. A portion of the exhaust gas G flowing through the exhaust pipe 7 flows into the tip end side cover 45 from the gas circulation hole 451 in the tip end side cover 45. Then, the exhaust gas G inside the tip end side cover 45 passes through the protective layer 20 and the diffusive resistance portion 32 of the sensor element 2 and is guided to the exhaust electrode 311.

The base end side cover 46 is provided on the base end side L2 in the longitudinal direction L of the housing 41. The base end side cover 46 covers a wiring portion positioned on the base end side L2 in the longitudinal direction L of the gas sensor 1 and protects the wiring portion from moisture contained in atmospheric air A and the like. The wiring portion is configured by the contact terminal 44, a connecting portion (connection fitting 441) between the contact terminal 44 and the lead wire 48 and the like serving as a portion electrically connected to the sensor element 2.

The bush 47 that holds a plurality of lead wires 48 is held on an inner peripheral side of a portion of the base end side L2 in the longitudinal direction L of the base end side cover 46. An atmospheric air introduction hole 461 for introducing the atmospheric air A from outside the gas sensor 1 is formed in the base end side cover 46. The atmospheric air introduction hole 461 is covered with a water-repellent filter 462. A base end position of the atmosphere duct 36 in the sensor element 2 is open to a space inside the base end side cover 46, and the atmospheric air A is guided to the atmosphere electrode 312 inside the atmosphere duct 36.

### Sensor Control Apparatus 5

As shown in FIG. 1, the lead wire 48 in the gas sensor 1 is electrically connected to the sensor control apparatus 5 that controls gas detection in the gas sensor 1. The sensor control device 5 performs electrical control of the gas sensor 1 in cooperation with an engine control apparatus 6 that controls a combustion operation in the engine. The sensor control apparatus 5 is configured using various control circuits, a computer, and the like. Here, the sensor control apparatus 5 may be constructed inside the engine control apparatus 6. The sensor control apparatus 5 is configured using a circuit 511 that applies a direct-current voltage between the exhaust electrode 311 and the atmosphere electrode 312, a circuit 512 that detects a current flowing between the exhaust electrode 311 and the atmosphere electrode 312, and the like.

### Working Effects

In the sensor element 2 of the gas sensor 1 according to the present embodiment, the porosity of the protective layer 20 covering the detection tip end portion 25 of the sensor element 2 is equal to or greater than 25%. As a result of this configuration, thermal conductivity of the protective layer 20 can be appropriately reduced, and occurrence of thermal shrinkage from the element body including the solid electrolyte body 31 and the heater 34 to the protective layer 20 is inhibited. In addition, the thickness t2 of the shielding side portion 22 of the protective layer 20 is greater than the thickness t1 of the heater side portion 21 of the protective layer 20. As a result of this configuration, the heat retention effect (thermal insulation effect) in the shielding side portion 22 of the protective layer 20 becomes higher than the heat retention effect in the heater side portion 21 of the protective layer 20. Occurrence of temperature distribution (temperature difference) in the opposing direction D in the detection tip end portion 25 of the sensor element 2 is inhibited during the course of temperature increase in the sensor element 2 by the heater 34. Furthermore, the effect of inhibiting the occurrence of thermal shrinkage and the effect of inhibiting the occurrence of temperature distribution are combined, and occurrence of thermal stress in the detection tip end portion 25 of the sensor element 2 can be inhibited.

In the course of temperature increase in the detection tip end portion 25 of the sensor element 2 by the heater 34, the temperature on the heater side of the detection tip end portion 25 becomes higher than the temperature on the shielding side of the detection tip end portion 25, and temperature distribution occurs in the opposing direction D in the detection tip end portion 25. Based on insight gained from research and development by the inventors, it has been found that, at this time, tensile stress directed outward in the width direction W is generated in the portion on the heater side of the detection tip end portion 25 and compressive stress directed inward in the width direction W is generated in the portion on the shielding side of the detection tip end portion 25. As a result of the tensile stress and the compressive stress being generated, a state in which cracks are easily formed occurs in the detection tip end portion 25.

In the sensor element 2 of the gas sensor 1 according to the present embodiment, the porosity of the protective layer 20 is set to be equal to or greater than 25%, and the thickness t2 of the shielding side portion 22 of the protective layer 20 provided in the detection tip end portion 25 is set to be greater than the thickness t1 of the heater side portion 21 of the protective layer 20 to mitigate the occurrence of tensile stress and compression stress based on the temperature distribution. That is, the heat retention effect in the heater side portion 21 of the protective layer 20 is reduced due to the thickness t1 of the heater side portion 21 being relatively small. Meanwhile, the heat retention effect in the shielding side portion 22 of the protective layer 20 is increased by the thickness t2 of the shielding side portion 22 being relatively large. As a result of this configuration, the temperature distribution occurring in the opposing direction D in the detection tip end portion 25 of the sensor element 2 is mitigated. Therefore, occurrence of thermal stress in the detection tip end portion 25 is inhibited, and formation of cracks in the detection tip end portion 25 can be inhibited.

A timing at which temperature increase stress occurring in the sensor element 2 is highest is at the time of sensor startup after engine startup. During sensor startup, actual energization of the heater 34 is performed and the sensor element 2 is activated at an early stage. In addition, there are also cases in which control to mitigate temperature increase stress occurring in the sensor element 2 is performed by slight energization being performed before the actual energization of the heater 34. However, increasing the temperature of the sensor element 2 as quickly as possible during actual energization is key to early activation.

In the sensor element 2 of the gas sensor 1 according to the present embodiment, through contrivance of the protective layer 20 covering the detection tip end portion 25 of the sensor element 2, formation of cracks in the detection tip end portion 25 can be inhibited even in cases in which a temperature increase speed of the sensor element 2 is set to be equal to or greater than 20° C./s and the sensor element 2 is activated at an early stage.

In this manner, as a result of the gas sensor 1 according to the present embodiment, the likelihood of cracks forming in the detection tip end portion 25 of the sensor element 2 can be more effectively reduced.

### Second Embodiment

According to a present embodiment, the sensor element 2 in which a portion of the protective layer 20 has a two-layer structure is described. As shown in FIG. 5, the shielding side portion 22 of the protective layer 20 according to the present embodiment is configured by an inner layer 221 that has a relatively large porosity, and an outer layer 222 that is laminated onto the outer side of the inner layer 221 and has a relatively small porosity compared to the inner layer 221. The inner layer 221 has a higher porosity than the heater side portion 21 and the outer layer 222 of the protective layer 20 to increase the heat retention effect in the portion on the shielding side in the opposing direction D of the sensor element 2.

The overall protective layer 20 excluding the inner layer 221 is composed of the same type of ceramic material. The inner layer 221 is composed of a ceramic material having a differing porosity from the other portions. More specifically, the heater side portion 21, the side portions 23, and the outer layer 222 of the protective layer 20 according to the present embodiment are composed of the same type of first ceramic material that has a porosity of equal to or greater than 25%. The inner layer 221 is composed of a second ceramic material that has a higher porosity than the first ceramic material.

The thickness t2 of the shielding side portion 22 of the protective layer 20 refers to the thickness t2 of the inner layer 221 and the outer layer 222 combined. In addition, the thickness t2 of the shielding side portion 22 that is the inner layer 221 and the outer layer 222 combined is greater than the thickness t1 of the heater side portion 21.

For example, the inner layer 221 may be formed having a thickness of equal to or greater than 5 μm. The remaining portion of the protective layer 20 excluding the inner layer 221 may be determined within a range enabling protection from cracking of the element body of the sensor element 2 due to water exposure. As a result of the shielding side portion 22 of the protective layer 20 being configured by the inner layer 221 and the outer layer 222, the heat retention effect of the shielding side portion 22 can be further increased and occurrence of temperature distribution in the opposing direction D in the detection tip end portion 25 of the sensor element 25 can be further inhibited.

Other configurations, working effects, and the like of the gas sensor 1 according to the present embodiment are similar to the configurations, working effects, and the like according to the first embodiment. In addition, according to the present embodiment as well, constituent elements denoted by reference numbers identical to the reference numbers according to the first embodiment are similar to the constituent elements according to the first embodiment.

### Confirmation Test 1

In a present confirmation test, an effect the magnitude of the porosity in the protective layer 20 has on durability of the sensor element 2 was confirmed. Specifically, regarding a plurality of samples of the sensor element 2 of which the porosities of the protective layer 20 differ, whether cracks are formed in each sample was confirmed by a voltage applied to the heater 34 to heat the sensor element 2 being changed as appropriate. The porosity of the protective layer 20 in the samples was changed within a range of 8% to 55%, and the applied voltage was changed within a range of 10 to 20 V. In the protective layer 20 of each sample, the thickness t1 of the heater side portion 21 and the thickness t2 of the shielding side portion 22 were the same at about 500 μm.

Table 1 shows results of the confirmation test 1. In Table 1, a case in which cracks are not formed in any portion of the sensor element 2 is indicated by a symbol O and a case in which cracks are formed in any portion of the sensor element 2 is indicated by a symbol x.

TABLE 1

| | | Porosity [%] | | | | | | | | | | |
|---|---|---|---|---|---|---|---|---|---|---|---|---|
| | | 8 | 11 | 16 | 20 | 25 | 28 | 35 | 37 | 41 | 46 | 55 |
| Voltage | 20 | × | × | × | × | × | × | × | × | × | × | × |
| [V] | 19 | × | × | × | × | × | × | × | × | × | × | × |
| | 18 | × | × | × | × | × | × | × | × | × | × | × |
| | 17 | × | × | × | × | × | × | × | × | × | × | × |
| | 16 | × | × | × | × | × | × | × | × | × | × | ∘ |
| | 15 | × | × | × | × | × | × | × | × | ∘ | ∘ | ∘ |
| | 14 | × | × | × | × | × | × | ∘ | ∘ | ∘ | ∘ | ∘ |
| | 13 | × | × | × | × | × | ∘ | ∘ | ∘ | ∘ | ∘ | ∘ |
| | 12 | × | × | × | × | ∘ | ∘ | ∘ | ∘ | ∘ | ∘ | ∘ |
| | 11 | × | × | × | × | ∘ | ∘ | ∘ | ∘ | ∘ | ∘ | ∘ |
| | 10 | × | × | × | × | ∘ | ∘ | ∘ | ∘ | ∘ | ∘ | ∘ |

When the porosity of the protective layer 20 was equal to or less than 20%, cracks formed in the sample of the sensor element 2 even when the applied voltage was 10V. Meanwhile, when the porosity of the protective layer 20 was 25%, cracks were not formed until the applied voltage became 12 V. Results were obtained that indicated that, as the porosity increased from 25%, cracks did not form even when the applied voltage further increased. In particular, it has become clear that, as a result of the porosity of the protective layer 20 being equal to or greater than 25%, the heat retaining effect in the detection tip end portion 25 of the sensor element 2 increases and durability of the sensor element 2 increases. In addition, the porosity of the protective layer 20 may be set to be equal to or less than 55%, for example, taking into consideration performance against water exposure, strength, and the like of the protective layer 20.

### Confirmation Test 2

In a present confirmation test, effects that a ratio of the thickness t2 of the shielding side portion 22 to the thickness t1 of the heater side portion 21 of the protective layer 20 has on the durability of the sensor element 2 was confirmed. Specifically, regarding a plurality of samples of the sensor element 2 of which the thickness ratios differ, whether cracks are formed in each sample was confirmed by the voltage applied to the heater 34 being changed as appropriate. The ratio of the thicknesses in the samples was changed within a range of 0.85 to 3.0 times, and the applied voltage was changed within a range of 10 to 20 V. The porosity of the protective layer 20 in the samples was 25%.

Table 2 shows results of the confirmation test 2. In Table 2, a case in which cracks are not formed in any portion of the sensor element 2 is indicated by a symbol O and a case in which cracks are formed in any portion of the sensor element 2 is indicated by a symbol x.

TABLE 2

| | | Thickness of the shielding side portion/thickness of | | | | | | | | | | | |
|---|---|---|---|---|---|---|---|---|---|---|---|---|---|
| | | the heater side portion [times] | | | | | | | | | | | |
| | | 0.85 | 1.0 | 1.3 | 1.4 | 1.5 | 1.7 | 1.8 | 1.9 | 2.1 | 2.5 | 2.8 | 3.0 |
| Voltage | 20 | × | × | × | × | × | × | × | × | × | × | × | × |
| [V] | 19 | × | × | × | × | × | × | × | × | × | × | × | × |
| | 18 | × | × | × | × | × | × | × | × | × | × | × | × |
| | 17 | × | × | × | × | ∘ | ∘ | ∘ | ∘ | ∘ | ∘ | ∘ | |
| | 16 | × | × | ∘ | ∘ | ∘ | ∘ | ∘ | ∘ | ∘ | ∘ | ∘ | ∘ |
| | 15 | × | × | ∘ | ∘ | ∘ | ∘ | ∘ | ∘ | ∘ | ∘ | ∘ | ∘ |
| | 14 | × | × | ∘ | ∘ | ∘ | ∘ | ∘ | ∘ | ∘ | ∘ | ∘ | ∘ |
| | 13 | × | ∘ | ∘ | ∘ | ∘ | ∘ | ∘ | ∘ | ∘ | ∘ | ∘ | ∘ |
| | 12 | ∘ | ∘ | ∘ | ∘ | ∘ | ∘ | ∘ | ∘ | ∘ | ∘ | ∘ | ∘ |
| | 11 | ∘ | ∘ | ∘ | ∘ | ∘ | ∘ | ∘ | ∘ | ∘ | ∘ | ∘ | ∘ |
| | 10 | ∘ | ∘ | ∘ | ∘ | ∘ | ∘ | ∘ | ∘ | ∘ | ∘ | ∘ | ∘ |

It has become clear that, as the ratio of the thickness t2 of the shielding side portion 22 to the thickness t1 of the heater side portion 21 increases, formation of cracks in the samples of the sensor element 2 is inhibited even when the applied voltage increases. In addition, it has become clear that the cracks are easily formed even when the applied voltage is low, if the ratio of the protective layer 20 is less than 1.3 times. Therefore, it has become clear that, as a result of the ratio of the thickness t2 of the shielding side portion 22 to the thickness t1 of the heater side portion 21 being equal to or greater than 1.3 times, occurrence of temperature distribution in the opposing direction D in the detection tip end portion 25 of the sensor element 2 is inhibited, and durability of the sensor element 2 is increased. In addition, the ratio of the thickness t2 of the shielding side portion 22 to the thickness t1 of the heater side portion 21 may be set to be equal to or less than 3.0 times, for example, taking into consideration performance against water exposure and the like of the protective layer 20.

### Confirmation Test 3

In a present confirmation test, effects that the thickness t2 of the shielding side portion 22 of the protective layer 20 has on the durability of the sensor element 2 was confirmed. Specifically, regarding a plurality of samples of the sensor element 2 of which the thicknesses t2 of the shielding side portion 22 of the protective layer 20 differ, whether cracks are formed in each sample was confirmed by the voltage applied to the heater 34 being changed as appropriate. The thickness t2 of the shielding side portion 22 of the protective layer 20 was changed within a range of 112 to 730 μm, and the applied voltage was changed within a range of 10 to 20 V. In the protective layer 20 of the samples, the porosity was 25% and the ratio of the thickness t2 of the shielding side portion 22 to the thickness t1 of the heater side portion 21 was set to 1.3 times.

Table 3 shows results of the confirmation test 3. In Table 3, a case in which cracks are not formed in any portion of the sensor element 2 is indicated by a symbol O and a case in which cracks are formed in any portion of the sensor element 2 is indicated by a symbol x.

TABLE 3

| | | Thickness of the shielding side portion [μm] | | | | | | | | | | |
|---|---|---|---|---|---|---|---|---|---|---|---|---|
| | | 112 | 201 | 259 | 311 | 428 | 498 | 509 | 582 | 623 | 687 | 730 |
| Voltage | 20 | × | × | × | × | × | × | × | × | × | ∘ | ∘ |
| [V] | 19 | × | × | × | × | × | × | ∘ | ∘ | ∘ | ∘ | ∘ |
| | 18 | × | × | × | × | × | ∘ | ∘ | ∘ | ∘ | ∘ | ∘ |
| | 17 | × | × | × | × | × | ∘ | ∘ | ∘ | ∘ | ∘ | ∘ |
| | 16 | × | × | × | × | ∘ | ∘ | ∘ | ∘ | ∘ | ∘ | ∘ |
| | 15 | × | × | ∘ | ∘ | ∘ | ∘ | ∘ | ∘ | ∘ | ∘ | ∘ |
| | 14 | × | ∘ | ∘ | ∘ | ∘ | ∘ | ∘ | ∘ | ∘ | ∘ | ∘ |
| | 13 | ∘ | ∘ | ∘ | ∘ | ∘ | ∘ | ∘ | ∘ | ∘ | ∘ | ∘ |
| | 12 | ∘ | ∘ | ∘ | ∘ | ∘ | ∘ | ∘ | ∘ | ∘ | ∘ | ∘ |
| | 11 | ∘ | ∘ | ∘ | ∘ | ∘ | ∘ | ∘ | ∘ | ∘ | ∘ | ∘ |
| | 10 | ∘ | ∘ | ∘ | ∘ | ∘ | ∘ | ∘ | ∘ | ∘ | ∘ | ∘ |

It has become clear that, as the thickness t2 of the shielding side portion 22 increases, formation of cracks in the samples of the sensor element 2 is inhibited even when the applied voltage increases. In addition, it has become clear that the cracks are easily formed even when the applied voltage is low, if the thickness t2 of the shielding side portion 22 is less than 498 μm. Therefore, it has become clear that, as a result of the thickness t2 of the shielding side portion 22 being equal to or greater than 498 μm, durability of the sensor element 2 is increased. In addition, the thickness t2 of the shielding side portion 22 may be set to be equal to or less than 730 μm, for example, taking into consideration the extent to which the occurrence of temperature distribution is inhibited.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A gas sensor comprising:
a sensor element that detects a gas contained in a gas to be detected, wherein:
the sensor element includes
a solid electrolyte body in which an electrode that is exposed to the gas to be detected is provided in a detection tip end portion in a longitudinal direction of the sensor element,
a heater that includes a heat generating unit in a position opposing the electrode and is disposed opposing the solid electrolyte body, and
a protective layer that covers the detection tip end portion and has a porosity of equal to or greater than 25%; and
the protective layer includes
a shielding side portion that is a planar portion on a side of the protective layer on which the solid electrolyte body is positioned in an opposing direction of the solid electrolyte body and the heater, and
a heater side portion that is a planar portion on a side of the protective layer on which the heater is positioned in the opposing direction, and
a thickness of the shielding side portion is greater than a thickness of the heater side portion.

2. The gas sensor according to claim 1, wherein:
in a cross-section orthogonal to the longitudinal direction of the sensor element in a heat generation center position in the longitudinal direction of the heat generating unit,
an overall thickness of a shielding side portion of the protective layer is equal to or greater than 1.3 times an overall thickness of a heater side portion of the protective layer.

3. The gas sensor according to claim 2, wherein:
the thickness of the shielding side portion of the protective layer is equal to or greater than 498 μm.

4. The gas sensor according to claim 3, wherein:
a thickness of a side portion of the protective layer positioned on both sides in a width direction orthogonal to both the longitudinal direction and the opposing direction is greater than the thickness of the heater side portion of the protective layer.

5. The gas sensor according to claim 4, wherein:
the sensor element excluding the protective layer has a composition in which a proportion of volume occupied by a zirconia material is largest.

6. The gas sensor according to claim 5, wherein:
the shielding side portion of the protective layer is configured by an inner layer, and an outer layer that is laminated onto an outer side of the inner layer and has a smaller porosity than the inner layer.

7. The gas sensor according to claim 1, wherein:
the thickness of the shielding side portion of the protective layer is equal to or greater than 498 μm.

8. The gas sensor according to claim 1, wherein:
a thickness of a side portion of the protective layer positioned on both sides in a width direction orthogonal to both the longitudinal direction and the opposing direction is greater than the thickness of the heater side portion of the protective layer.

9. The gas sensor according to claim 1, wherein:
the sensor element excluding the protective layer has a composition in which a proportion of volume occupied by a zirconia material is largest.

10. The gas sensor according to claim 1, wherein:
the shielding side portion of the protective layer is configured by an inner layer, and an outer layer that is laminated onto an outer side of the inner layer and has a smaller porosity than the inner layer.
